(19) United States
(12) Patent Application Publication
(10) Pub. No.: US 2018/0035637 A1
(43) Pub. Date: Feb. 8, 2018

(54) Working Chute

(71) Applicant: Burlington Welding LLC, Cherokee, OK (US)

(72) Inventor: Robert Leroy Wilson, Cherokee, OK (US)

(73) Assignee: Burlington Welding LLC, Cherokee, OK (US)

(21) Appl. No.: 15/667,688

(22) Filed: Aug. 3, 2017

Related U.S. Application Data
(60) Provisional application No. 62/370,555, filed on Aug. 3, 2016.

(51) Int. Cl. A01K 1/06; B60P 3/04; B65D 88/52; A01K 15/04

(52) U.S. Cl. CPC A01K 1/0613; A01K 15/04; B60P 3/04; B65D 88/522; B60G 21/0551

(57) ABSTRACT

Embodiments of the Working Chute are comprised of A working livestock chute comprised of an adjustable width alleyway from 18 inches wide to 36 inches wide; one or more double hinges; one or more catwalks; one or more pins; a plurality of chains; a stabilizer bar; support straps; one or more palpation gate assemblies; a hydraulic gooseneck; a hydraulic gooseneck lifting means; an underslung torsion tube; and a plurality of free floating gates.

### CROSS-REFERENCE TO RELATED APPLICATIONS

Not Applicable.

### STATEMENT REGARDING FEDERALLY SPONSORED RESEARCH OR DEVELOPMENT

Not applicable

### BACKGROUND OF THE EMBODIMENTS

### Field of the Embodiments

The general field of the embodiments of the Working Chute are livestock equipment, particularly livestock chutes.

### Description of Prior Art

Ranchers and other owners of livestock commonly have a need for a may need to sort the livestock for veterinary procedures, to sort by gender, or for marketing purposes. Many times this sorting must take place in a remote location or a location without a permanent corral. Building corrals in such locations is prohibitively time consuming and expensive. Therefore, a corral that is both portable and that serves the various sorting needs of a livestock owner is of great value.

### SUMMARY OF THE EMBODIMENTS

Embodiments of the Embodiments of the Working Chute are comprised of A working livestock chute comprised of an adjustable width alleyway from 18 inches wide to 36 inches wide; one or more double hinges; one or more catwalks; one or more pins; a plurality of chains; a stabilizer bar; support straps; one or more palpation gate assemblies; a hydraulic gooseneck; a hydraulic gooseneck lifting means; an underslung torsion tube; and a plurality of free floating gates.

In this respect, before explaining at least one embodiment of the embodiments in detail, it is to be understood that the embodiment is not limited in this application to the details of construction and to the arrangements of the components set forth in the following description or illustrated in the drawings. The embodiment or embodiments are capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be used as a basis for the designing of other structures, methods and systems for carrying out the several purposes of the embodiments. Additional benefits and advantages of the embodiments will become apparent in those skilled in the art to which the present embodiments relate from the subsequent description of the preferred embodiment and the appended claims, taken in conjunction with the accompanying drawings. It is important, therefore, that the claims be regarded as including such equivalent constructions insofar as they do not depart from the spirit and scope of the embodiments.

Further, the purpose of the foregoing abstract is to enable relevant patent granting authorities and the public generally, and especially the scientist, engineers and practitioners in the art who are not familiar with patent or legal terms or phraseology, to determine quickly from a cursory inspection the nature and essence of the technical disclosure of the application. The abstract is neither intended to define the embodiments of the application which is measured by the claims, nor is it intended to be limiting as to the scope of the embodiments in any way.

### BRIEF DESCRIPTION OF THE DRAWINGS

FIG. 1 is a perspective view of an embodiment of the working chute with the gates closed and in a transportable configuration.

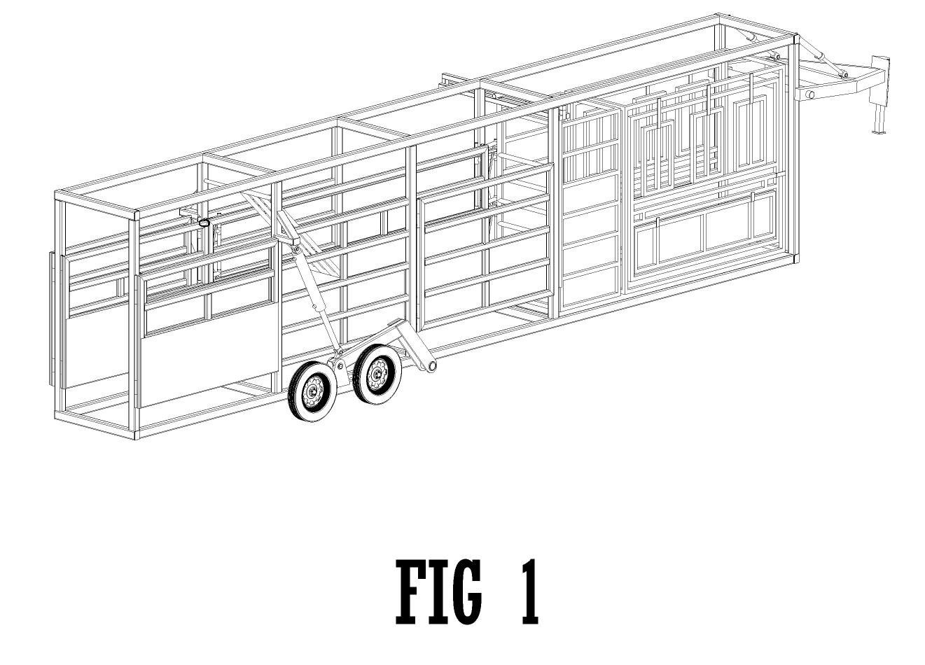

FIG. 2 is a perspective view of an embodiment of the working chute with the gates opened in a stationary position.

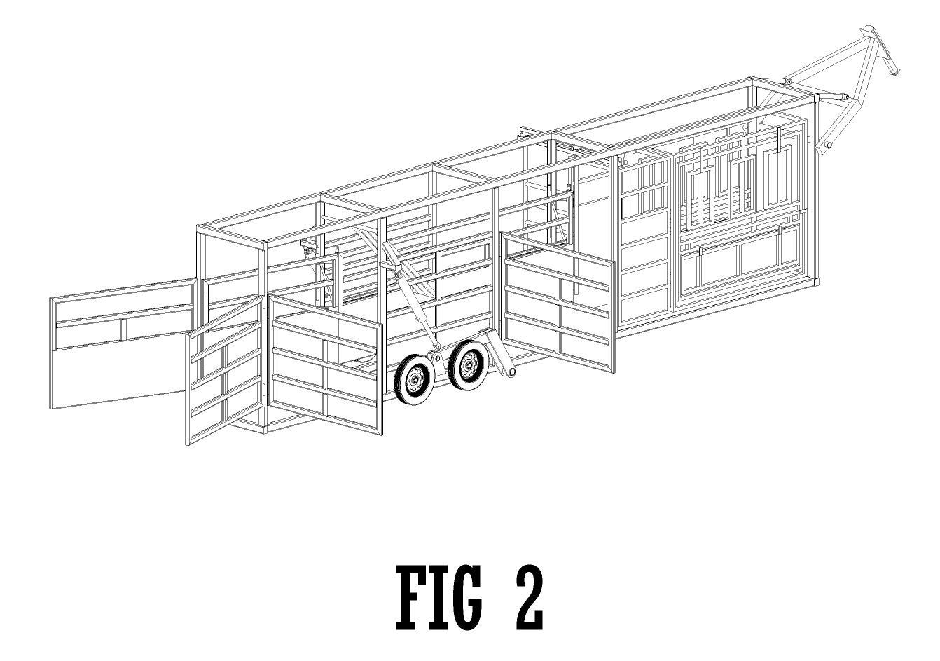

FIG. 3 is a perspective view of an embodiment of the working chute with the gates closed and in a transportable configuration.

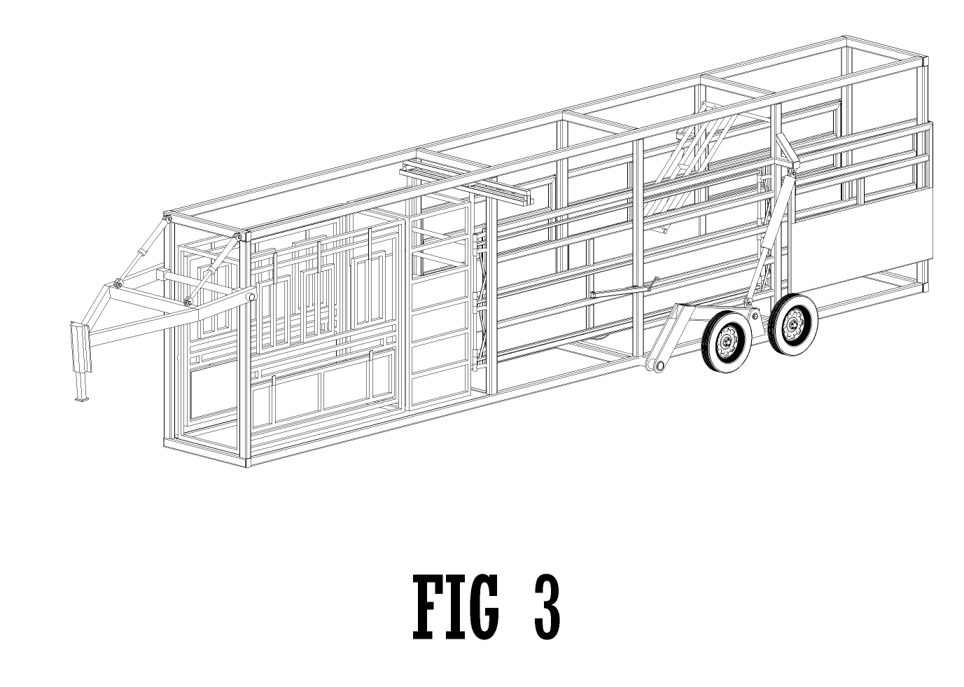

FIG. 4 is a perspective view of an embodiment of the working chute with the gates opened in a stationary position.

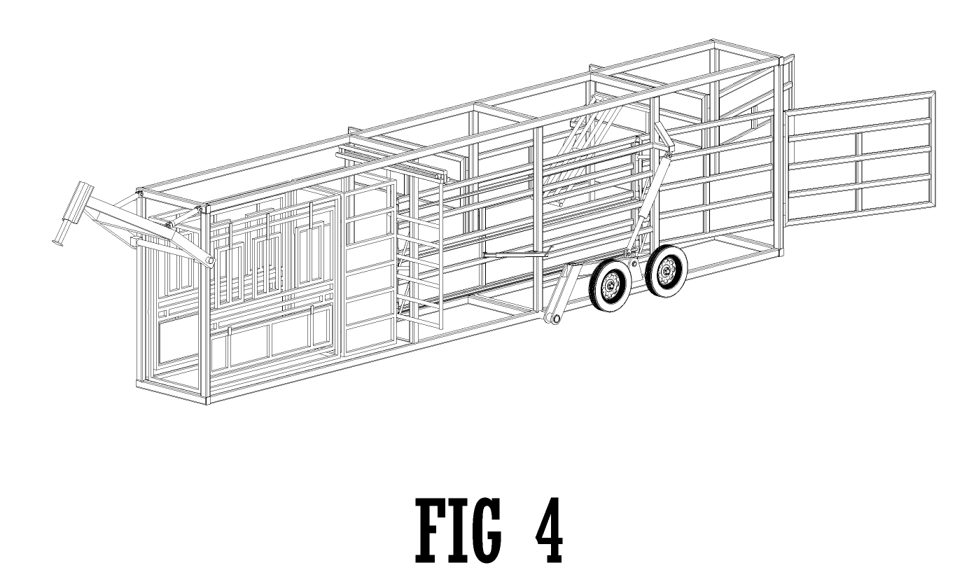

FIG. 5 is a side view of an embodiment of the working chute with the gates closed in a transportable configuration.

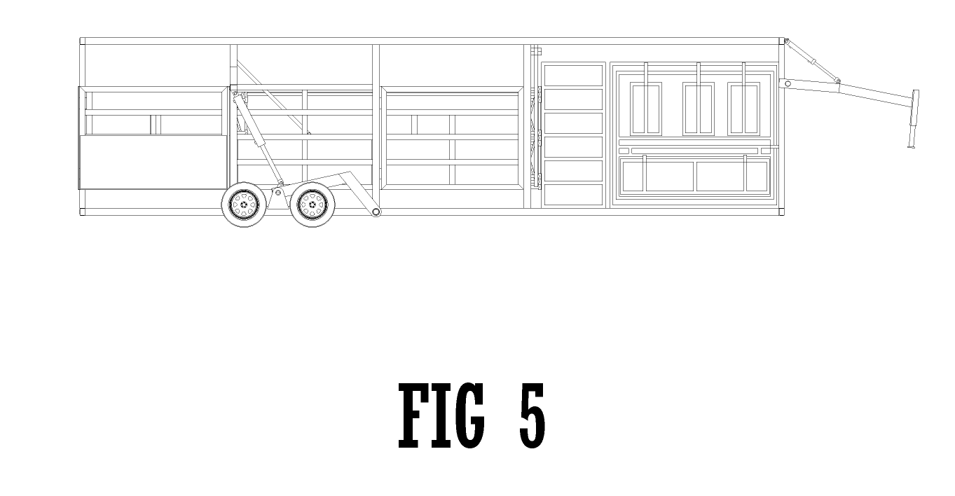

FIG. 6 is a side view of an embodiment of the working chute with the gates opened in a stationary position.

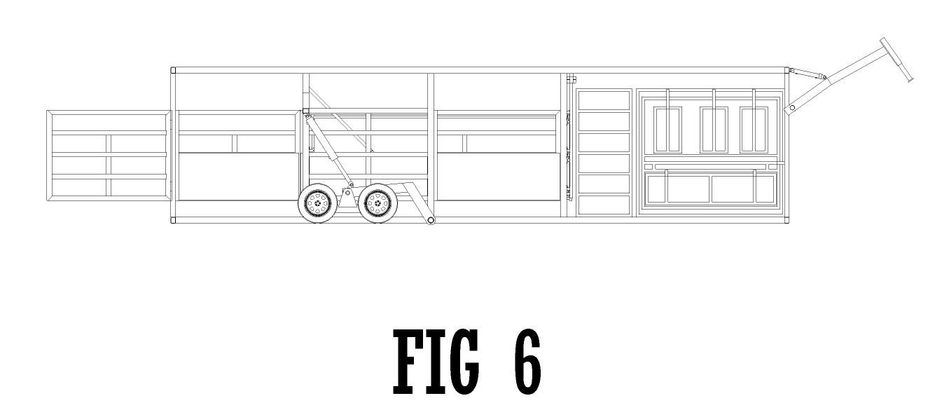

FIG. 7 is a top view of an embodiment of the working chute with the gates closed in a transportable configuration.

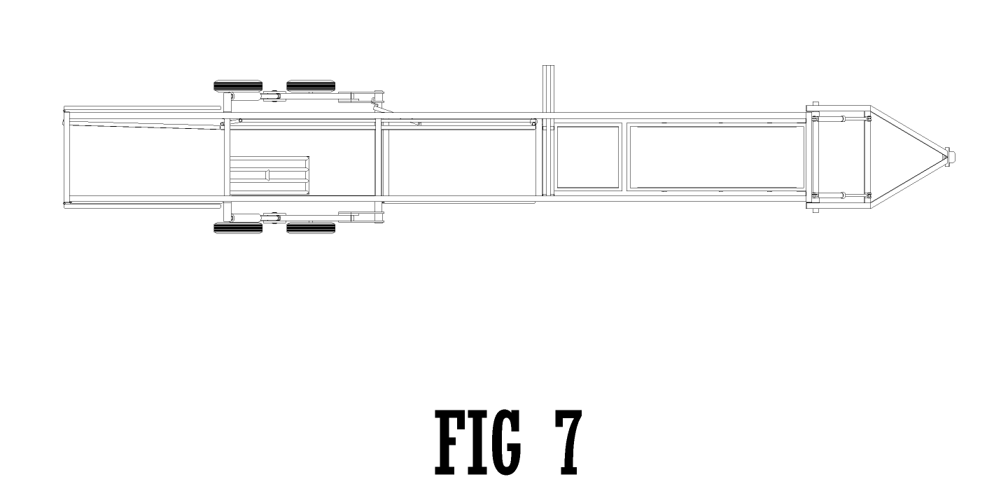

FIG. 8 is a top view of an embodiment of the working chute with the gates opened in a stationary position.

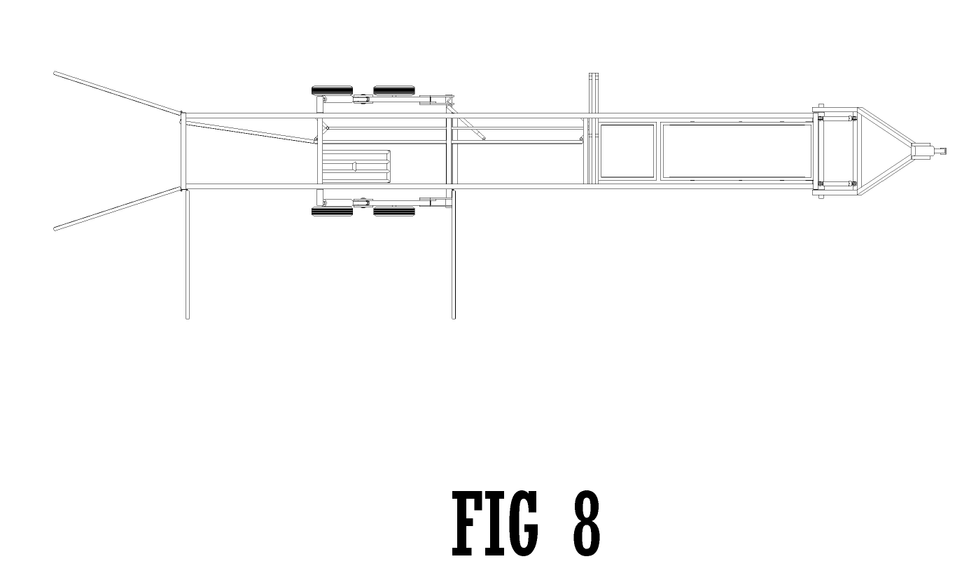

FIG. 9 is a perspective view of an embodiment of the working chute wheel assembly.

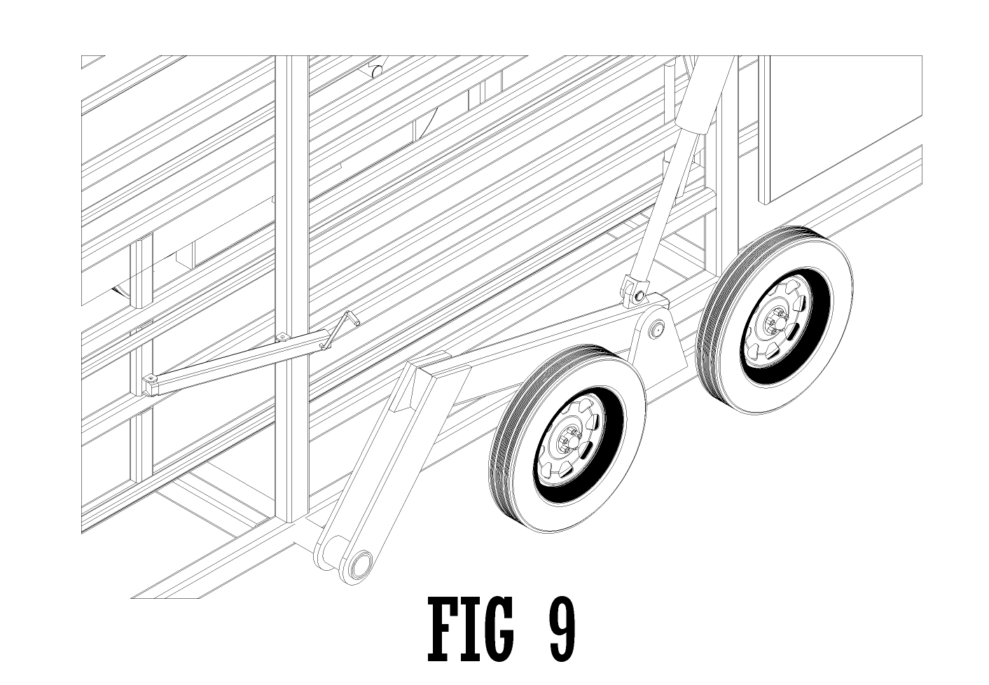

FIG. 10A is a side view of an embodiment of the working chute gooseneck hitch; FIG. 10B is a top view of an embodiment of the working chute gooseneck hitch.

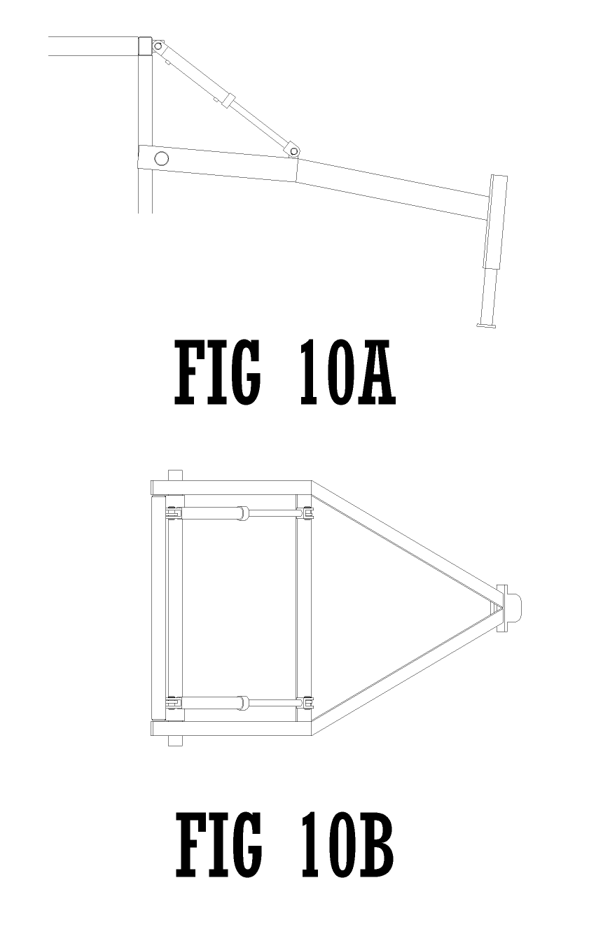

FIG. 11A is a side view of a single tire lift; FIG. 11B is a front view of a single tire lift.

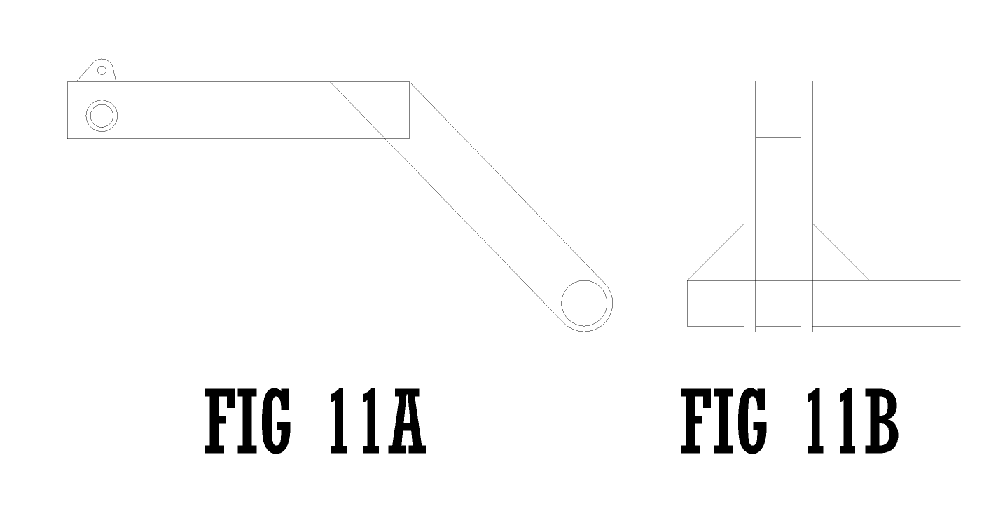

FIG. 12A is a side view of the rear axle bottom pivot point; FIG. 12B is a front view of the rear axle bottom pivot point.

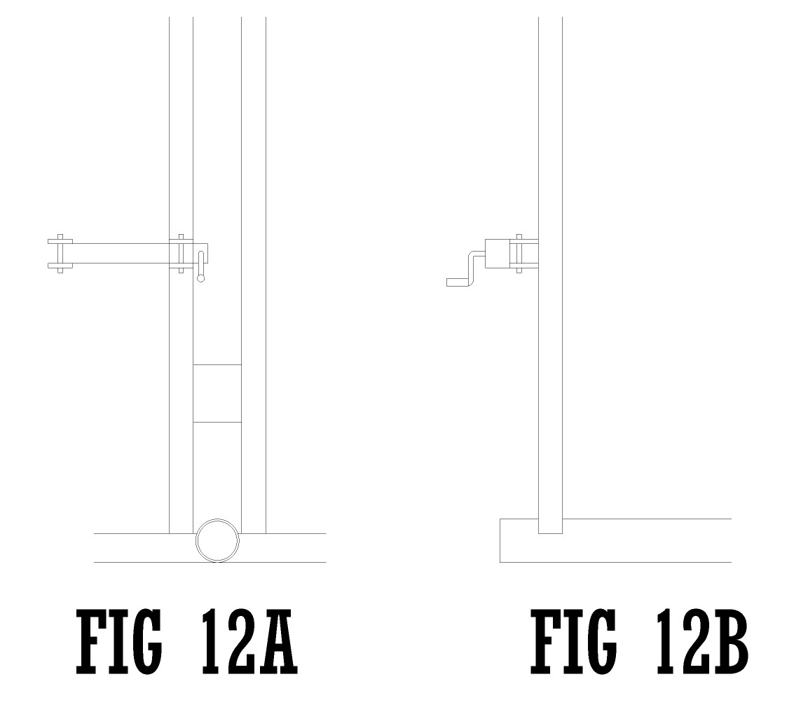

FIG. 13A is a schematic view of a rear view of an embodiment of the working chute showing the double alleyway into a single alleyway; FIG. 13B is a schematic view of one side of an embodiment of the working chute showing the double alleyway from the rear and into a single alleyway

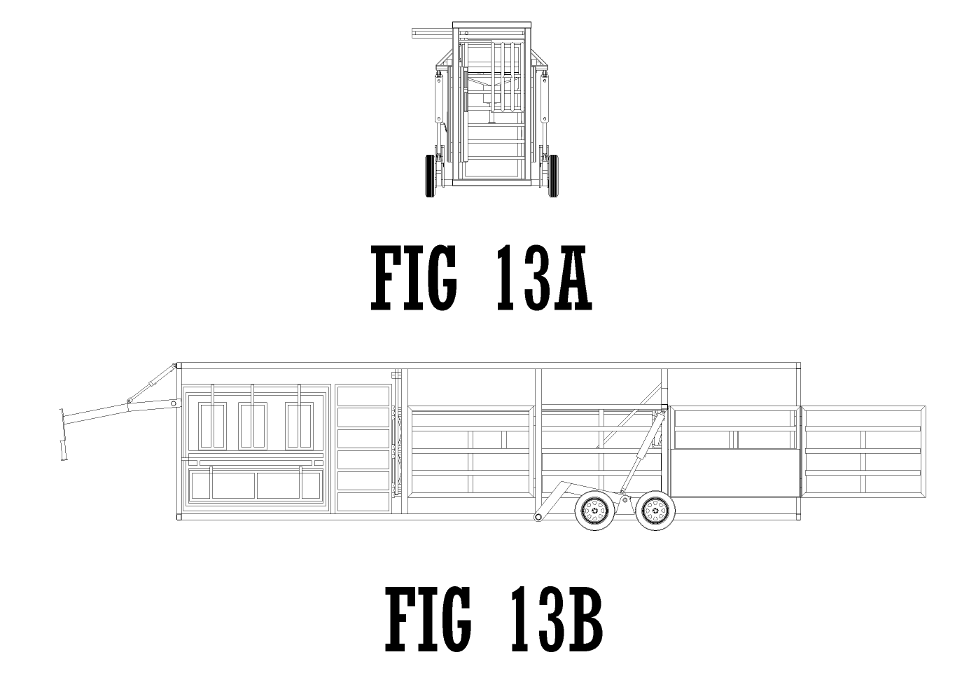

FIG. 14A is a side view of an embodiment of the working chute showing the axle assembly; FIG. 14B is a front view of an embodiment of the working chute showing the axle assembly.

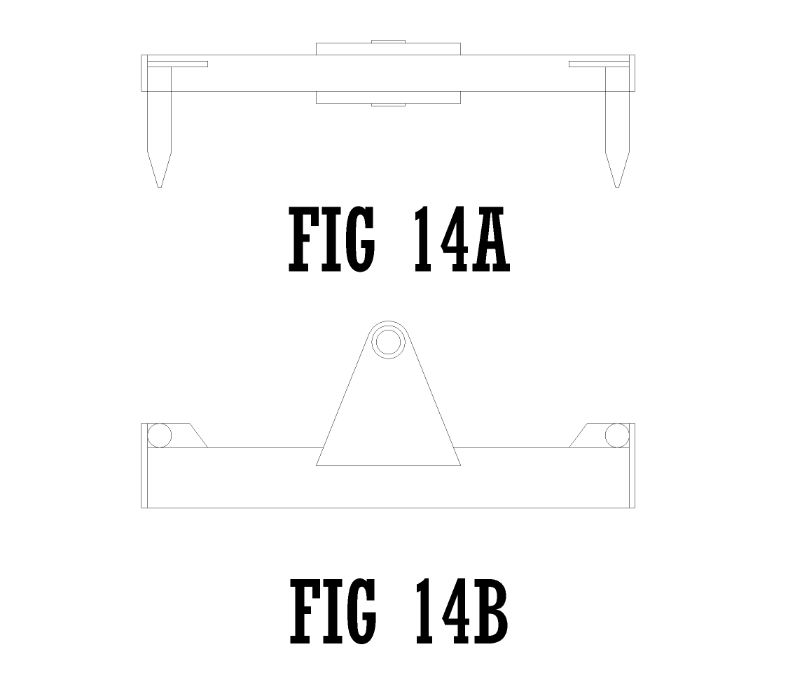

FIG. 15A is a side view of an embodiment of the rear list post; FIG. 15B is a side view of an embodiment of the rear list post.

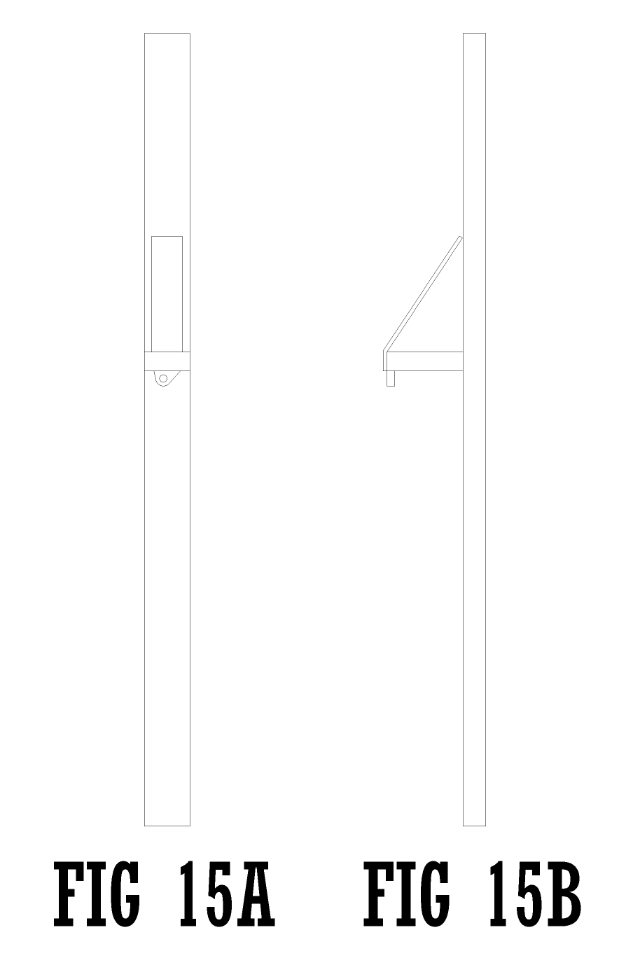

FIG. 16 is a schematic view of an adjustable arm for the side panel.

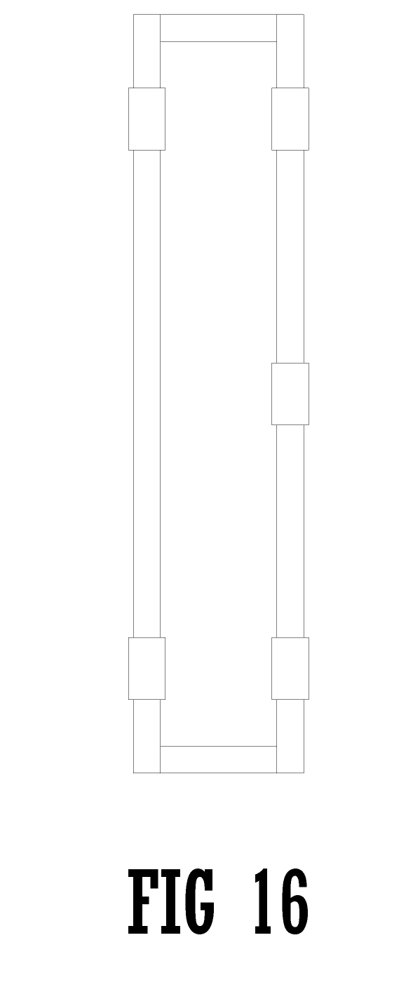

FIG. 17 is a schematic view of a folding side panel.

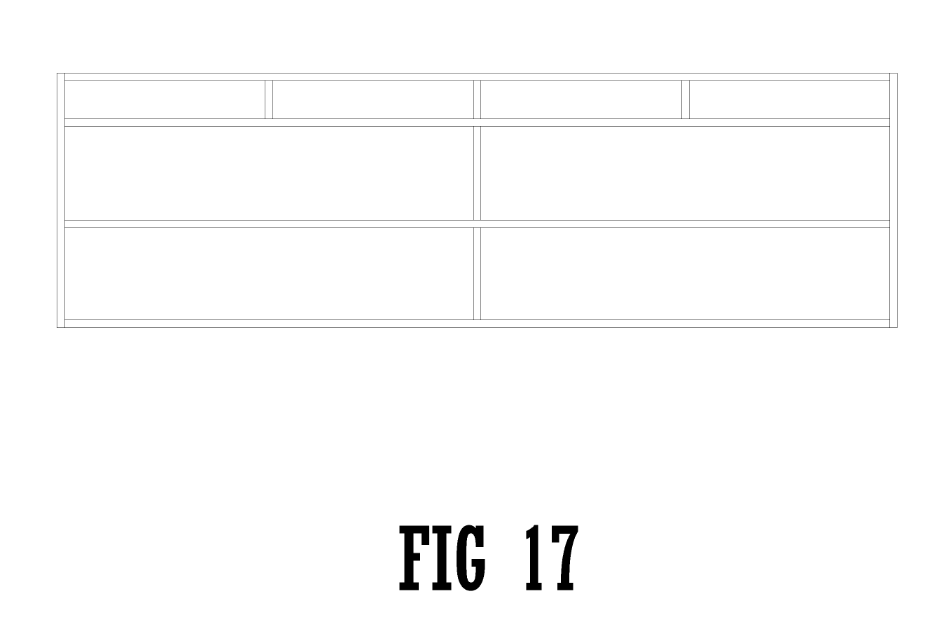

FIG. 18 is a schematic view of a rear alley.

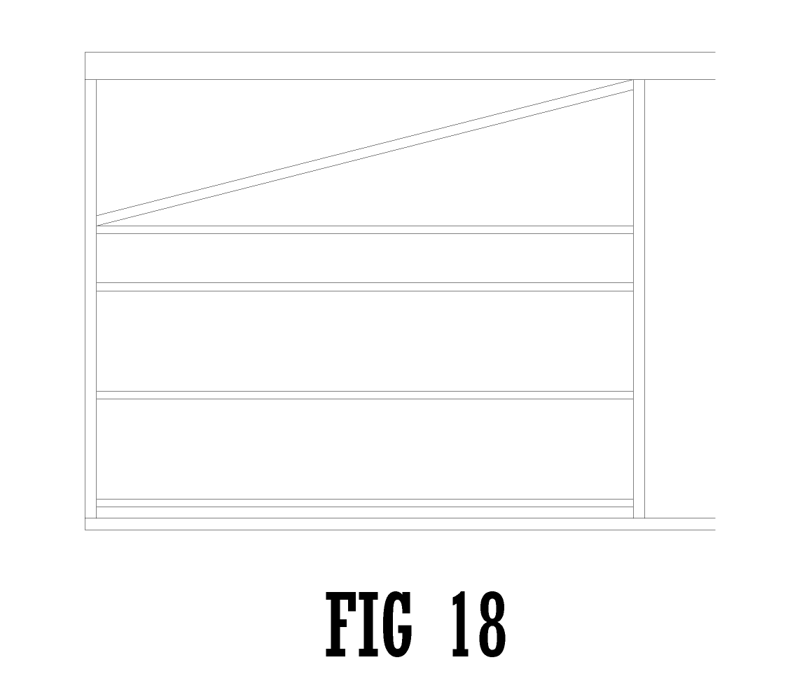

FIG. 19 is a schematic view of an eight-foot rear panel.

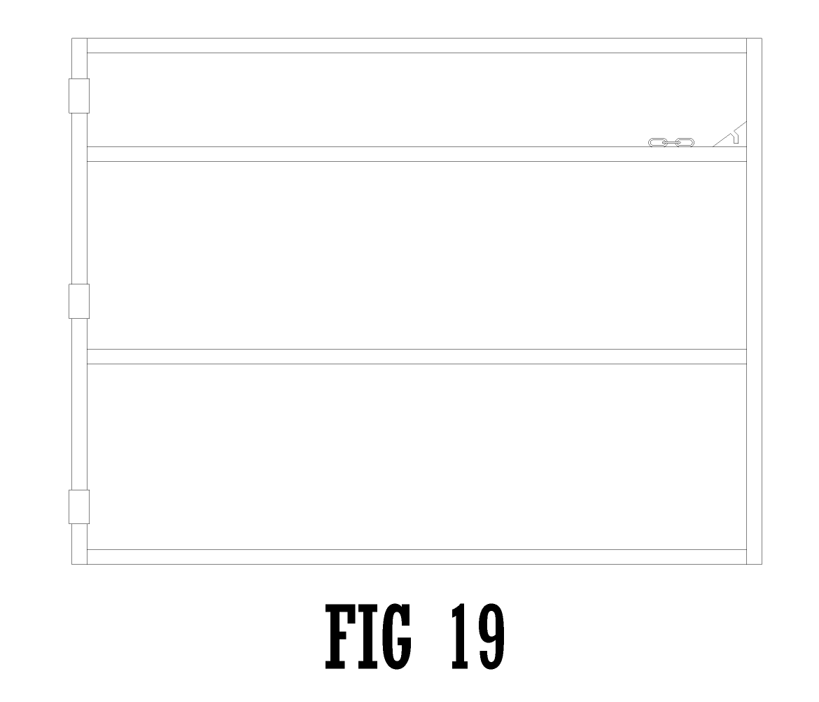

FIG. 20 is a schematic view of the end of a single alley.

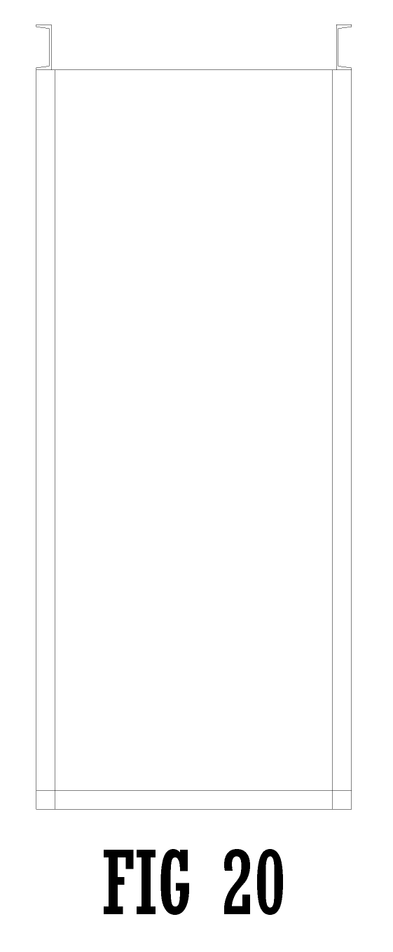

### DETAILED DESCRIPTION OF THE PREFERRED EMBODIMENTS

Embodiments of the Working Chute are comprised of: a) an adjustable width alleyway from 18 inches wide into 36 inches wide; b) double hinges which will let the side wall move in and which eliminates the problem of having a hole for the livestock to enter; c) catwalks on the left-hand side of the alleyway where the front section of the catwalk is a solid catwalk and where behind the wheel assembly the catwalk is held horizontal by two or more chains which can be released to fold down the catwalk for transport where the catwalk allows a user to stand on the side of the adjustable alleyway and look into the adjustable alleyway to inspect the livestock; d) a pin, that drops in there and locks those real panels in transport position; e) a plurality of chains where there are at least two chains on the left-hand side, and they are used to lift the catwalk up to a level position so a user can step on the catwalk and walk up and down it, work the cattle, get ready to transport; f) a stabilizer bar; g) support straps; h) palpation gate assemblies; i) a hydraulic gooseneck; j) a hydraulic gooseneck lifting means; k) an underslung torsion tube; and l) a plurality of free floating gates.

What we claim is:

1) A working livestock chute comprised of
a) an adjustable width alleyway from 18 inches wide to 36 inches wide;
b) a plurality double hinges;
c) one or more catwalks;
d) one or more pins;
e) a plurality of chains;
f) a stabilizer bar;
g) support straps;
h) one or more palpation gate assemblies;
i) a hydraulic gooseneck;
j) a hydraulic gooseneck lifting means;
k) an underslung torsion tube; and
l) a plurality of free floating gates.
